(19) United States
(12) Patent Application Publication
(10) Pub. No.: US 2024/0075648 A1
(43) Pub. Date: Mar. 7, 2024

(54) POWER TOOL AND CHAINSAW

(71) Applicant: Nanjing Chervon Industry Co., Ltd., Nanjing (CN)

(72) Inventors: Huaguo Zhu, Nanjing (CN); Minggui Xiao, Nanjing (CN); Lai Liu, Nanjing (CN)

(21) Appl. No.: 18/449,545

(22) Filed: Aug. 14, 2023

(30) Foreign Application Priority Data
Sep. 1, 2022 (CN) 202211065902.4
Sep. 1, 2022 (CN) 202211065904.3
Mar. 9, 2023 (CN) 202310224815.7
Mar. 9, 2023 (CN) 202320446967.7
Mar. 23, 2023 (CN) 202320589460.7

(51) Int. Cl. B27B 17/12; B27B 17/08

(52) U.S. Cl. CPC B27B 17/12; B27B 17/08; B27B 17/0083

(57) ABSTRACT

A power tool includes an output assembly, a first motor, a housing, and a liquid pump assembly, where the output assembly implements an operation, the first motor is used for driving the output assembly to operate, the housing is formed with a grip for a user to hold, the liquid pump assembly includes a liquid pump and a second motor for driving the liquid pump to operate, the liquid pump assembly is at least partially disposed within the grip, and a total length of the power tool is greater than or equal to 20 cm and less than or equal to 150 cm.

### RELATED APPLICATION INFORMATION

This application claims the benefit under 35 U.S.C. § 119(a) of Chinese Patent Application No. CN 202211065904.3, filed on Sep. 1, 2022, Chinese Patent Application No. CN 202211065902.4 filed on Sep. 1, 2022, Chinese Patent Application No. CN 202320589460.7, filed on Mar. 23, 2023, Chinese Patent Application No. CN 202310224815.7 filed on Mar. 9, 2023, and Chinese Patent Application No. CN 202320446967.7, filed on Mar. 9, 2023, which applications are incorporated herein by reference in their entireties.

### TECHNICAL FIELD

The present application relates to the technical field of electric devices and, in particular, to a power tool and a chainsaw.

### BACKGROUND

A chainsaw is a power tool mainly used for felling and bucking, which performs a cutting operation on wood through a reciprocating motion of a cutting element. In the chainsaw, the cutting element is generally driven by a motor, and since the cutting element needs to be lubricated or cooled during the reciprocating motion, an oil pump and an oil can need to be disposed inside the chainsaw.

In existing chainsaws, the oil can and the oil pump are generally disposed in the vicinity of the motor, and the motor that drives an output assembly to reciprocate synchronously drives the oil pump. Thus, a transmission assembly with a relatively complex structure needs to be disposed at an output end of the motor to connect the motor, the cutting element, and the oil pump at the same time. However, the transmission assembly includes a relatively large number of transmission pieces and occupies a relatively large space, which results in a relatively large overall size of the chainsaw and is not conducive to miniaturization.

### SUMMARY

The present application adopts the technical solutions below. A power tool includes: an output assembly for implementing an operation; a first motor for driving the output assembly to operate; a housing formed with a grip for a user to hold; and a liquid pump assembly including a liquid pump and a second motor for driving the liquid pump to operate. The liquid pump assembly is at least partially disposed within the grip, and a total length M of the power tool is greater than or equal to 20 cm and less than or equal to 150 cm.

In an example, the second motor and the liquid pump are both disposed within the grip.

In an example, the liquid pump assembly further includes an oil can to lubricate the output assembly, where the oil can is at least partially disposed on the front side of the first motor.

In an example, along an operation direction of the power tool, the liquid pump and the second motor are arranged substantially in a front and rear direction.

In an example, along the operation direction of the power tool, the liquid pump is disposed on the front side of the second motor.

In an example, the liquid pump and the second motor both extend along a preset direction at a preset angle relative to a horizontal direction.

In an example, the power tool further includes a battery pack coupling portion for coupling a battery pack.

In an example, the power tool further includes a circuit board at least partially disposed within a housing of the battery pack coupling portion.

In an example, the power tool further includes a circuit board for controlling both the first motor and the second motor.

In an example, the tool further includes a circuit board disposed between the first motor and at least part of the liquid pump assembly.

In an example, the liquid pump assembly includes an oil tube and a squeezing piece, where the oil tube includes an oil inlet end communicating with the oil can and an oil outlet end extending to the output assembly, and the squeezing piece is configured to squeeze the oil tube into deformation so that lubricating oil within the oil can is transportable to the output assembly through the oil tube.

In an example, the first motor is drivingly connected to the squeezing piece and configured to drive the squeezing piece to rotate about a first straight line to squeeze the oil tube into deformation so that the lubricating oil within the oil can is transported to the output assembly through the oil tube.

In an example, the power tool further includes an oil can for storing at least a liquid; where the liquid pump provides pressure for the liquid to flow so that the liquid within the oil can is capable of being released or sucked in, and the liquid pump includes a soft cover made of a flexible material and configured to be deformable to compress the liquid.

In an example, the housing is formed with an accommodation space in which a circuit board is disposed, and the housing is formed with an air inlet and an air outlet communicating with the accommodation space, where the air inlet and the air outlet are both disposed on the front side of the grip in a front and rear direction; and a heat dissipation airflow entering the accommodation space from the air inlet and flowing out from the air outlet flows through the circuit board and the first motor.

In an example, the power tool further includes a lower hand guard connected below the grip and a lubrication assembly for lubricating a saw chain, where the lubrication assembly includes an oil can at least partially disposed or formed within the lower hand guard.

The present application further provides a chainsaw including: a chain for implementing a cutting operation; a guide plate extending along a front and rear direction and used for guiding the chain; a first motor for driving the chain to perform the cutting operation; a housing formed with a grip for a user to hold; a liquid pump assembly including a liquid pump and a second motor for driving the liquid pump to operate to lubricate or cool the chain; and an oil can for lubricating the chain. The liquid pump assembly is at least partially disposed within the grip, and the first motor is disposed between the oil can and the liquid pump assembly.

In an example, power of the liquid pump in operation is greater than or equal to 0.2 W and less than or equal to 5 W.

In an example, a total length of the chainsaw is greater than or equal to 20 cm and less than or equal to 60 cm.

In an example, an overall weight of the chainsaw with a battery pack mounted is greater than or equal to 1.2 kg and less than or equal to 4 kg.

In an example, power of the first motor in operation is greater than or equal to 200 W and less than or equal to 800 W.

### BRIEF DESCRIPTION OF THE DRAWINGS

FIG. 1 is a structural view of a chainsaw according to an example of the present application;

FIG. 2 is a structural view of a chainsaw with part of a housing removed according to an example of the present application;

FIG. 3 is a front view of part of the structure shown in FIG. 2;

FIG. 4 is a structural view of a chainsaw with part of a housing and an oil can removed according to an example of the present application;

FIG. 5 is a structural view of a chainsaw with part of a housing and a first motor removed according to an example of the present application;

FIG. 6 is a structural view of a liquid pump assembly of a chainsaw according to an example of the present application;

FIG. 7 is a structural view illustrating a second motor and a liquid pump according to an example of the present application from an angle;

FIG. 8 is a structural view illustrating a second motor and a liquid pump according to an example of the present application from another angle;

FIG. 9 is a partial exploded view of a liquid pump according to an example of the present application;

FIG. 10 is an exploded view of some structures of a liquid pump according to an example of the present application;

FIG. 11 is an exploded view illustrating a liquid pump according to an example of the present application from an angle;

FIG. 12 is an exploded view illustrating a liquid pump according to an example of the present application from another angle;

FIG. 13 is a structural view illustrating a second housing of a liquid pump according to an example of the present application from an angle;

FIG. 14 is a structural view illustrating a second housing of a liquid pump according to an example of the present application from another angle;

FIG. 15 is a structural view of a flexible barrier pad of a liquid pump according to an example of the present application;

FIG. 16 is a structural view of a chainsaw according to an example of the present application;

FIG. 17 is an exploded view of a chainsaw according to an example of the present application;

FIG. 18 is a structure view of some structures of a chainsaw according to an example of the present application;

FIG. 19 is an exploded view of a peristaltic pump of a chainsaw according to an example of the present application;

FIG. 20 is a side view of a chainsaw according to an example of the present application;

FIG. 21 is a top view of a chainsaw according to an example of the present application;

FIG. 22 is a schematic view of an internal structure of a chainsaw according to an example of the present application;

FIG. 23 is a schematic view of a chainsaw with a lower hand guard completely detached according to an example of the present application;

FIG. 24 is a schematic view of a lower hand guard and a switch lock of a chainsaw according to an example of the present application;

FIG. 25 is a schematic view of a chainsaw with an end of a lower hand guard detached according to an example of the present application;

FIG. 26 is a schematic view of a switch lock of a chainsaw according to an example of the present application;

FIG. 27 is a schematic view illustrating that a chainsaw of the present application is placed on a horizontal plane; and

FIG. 28 is a schematic view of another chainsaw involved in the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear”” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

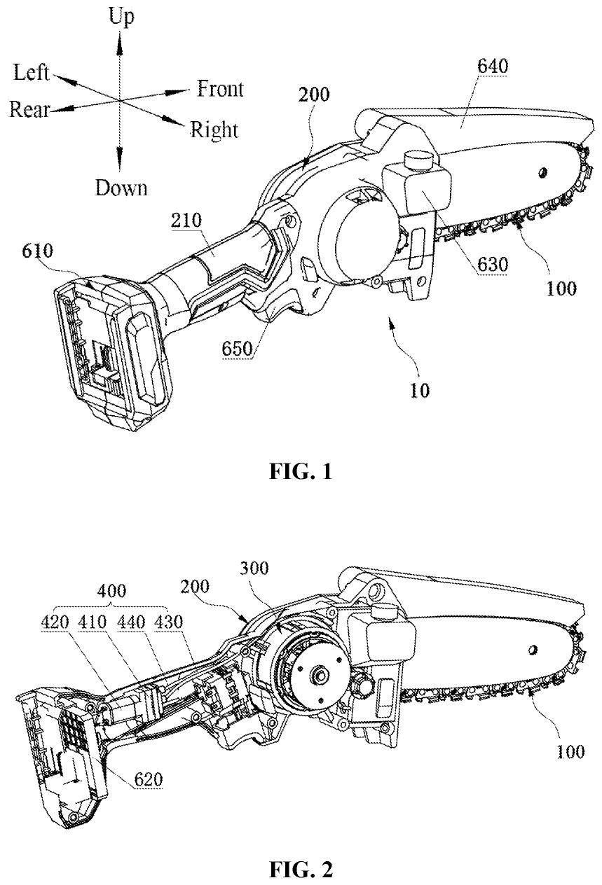

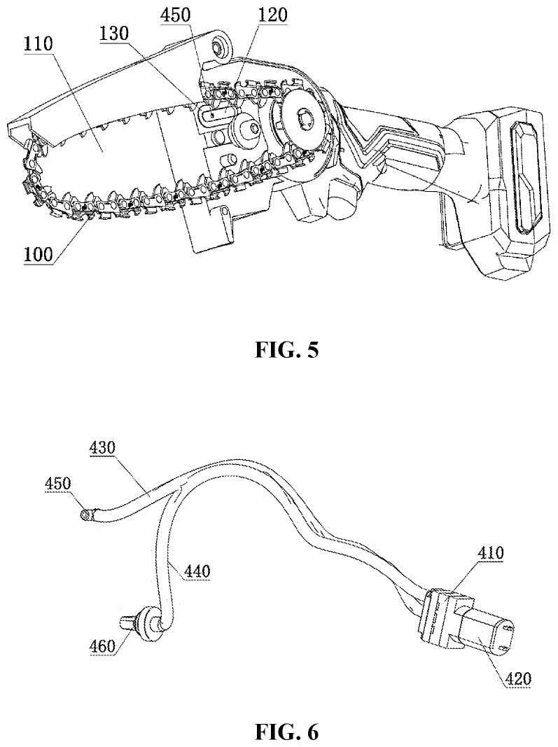

This example provides a power tool. As shown in FIGS. 1 to 5, the power tool includes an output assembly, a first motor 300, a housing 200, and a liquid pump assembly 400. The output assembly is used for implementing an operation. The power tool can have different functions by using different output assemblies. For example, the output assembly may be a chain 100 capable of performing a cutting operation so that the power tool has a cutting function. The first motor 300 is used for driving the output assembly to operate. The housing 200 is formed with a grip 210 for a user to hold, and the user may operate the power tool by holding the grip 210. A mounting cavity is formed within the housing 200, and part of the mounting cavity extends into the grip 210. The liquid pump assembly 400 is used for cooling or lubricating the output assembly.

In some examples, as shown in FIG. 1, in an operation direction of the power tool, the grip 210 is disposed behind the output assembly, the grip 210 has a cylindrical structure, and a cross-section perpendicular to the operation direction is substantially elliptical, and an extension direction of the grip 210 and an extension direction of the output assembly are arranged at an angle, for example, at an obtuse angle greater than 90° and less than 180°. In other examples, the angle between the extension direction of the grip 210 and the extension direction of the output assembly may be set to 90° as required, that is, the grip 210 is perpendicular to the output assembly. Alternatively, the angle between the extension direction of the grip 210 and the extension direction of the output assembly may be set to 180° as required, that is, the grip 210 is collinear with the output assembly. The shape of the grip 210 may be adjusted as required so long as the grip 210 is convenient for the user to hold to operate the power tool.

Specifically, the liquid pump assembly 400 includes a liquid pump 410 connected to an oil can 630, where the liquid pump 410 is driven to operate to provide pressure for a liquid in the oil can 630, thereby releasing the liquid inside the oil can 630 to lubricate or cool the output assembly. It is to be noted that the liquid here may be lubricating oil to lubricate the output assembly and accordingly, the liquid pump 410 is an oil pump; or the liquid here may be water to cool the output assembly and accordingly, the liquid pump 410 is a water pump. It is to be noted that the liquid is not limited to the lubricating oil or water, and the structure involved in the present application can be used as long as the liquid needs to be released from a reservoir 120 of the oil can 630 in the power tool. Additionally, the liquid pump 410 can not only release the liquid but also suck the liquid, that is, may be used for sucking a certain liquid so that the function implementable with the assistance of the liquid pump 410 is not limited to cooling and lubrication.

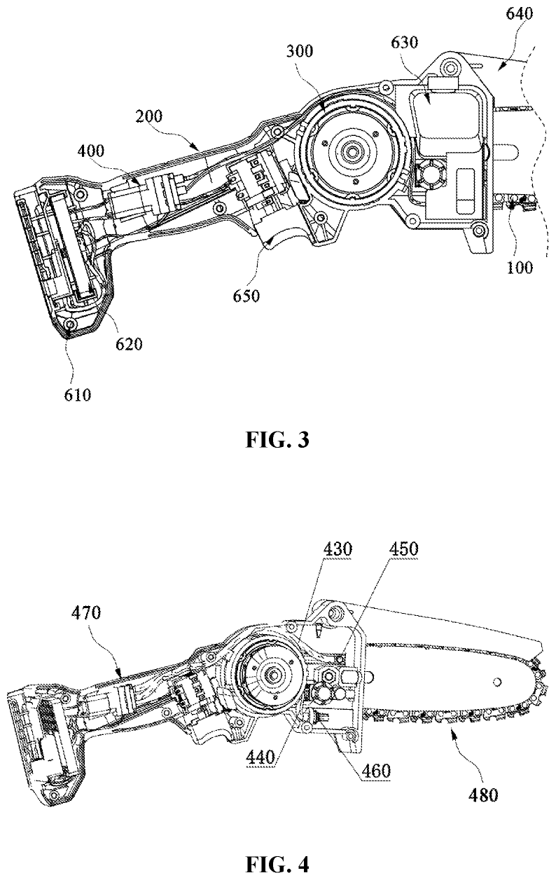

As shown in FIGS. 3 to 7, the liquid pump assembly 400 further includes the oil can 630, a first oil passage 430, and a second oil passage 440. The liquid pump 410 has a first opening 41131 and a second opening 41132, where the first opening 41131 communicates with an end of the first oil passage 430, an oil outlet 450 is provided at the other end of the first oil passage 430, the oil outlet 450 is disposed in the reservoir 120 formed by the output assembly, and the oil outlet 450 and the first oil passage 430 may be arranged at an angle, for example, perpendicular to each other. In some specific examples, when the power tool is a chainsaw 10, the output assembly includes a guide plate 110 and the chain 100 moving along the guide plate 110, the reservoir 120 may be formed by a sealing ring 130 disposed on the guide plate 110, the sealing ring 130 abuts against the guide plate 110, and part of the sealing ring 130 is embedded into the housing 200 and part of the sealing ring 130 is higher than the surrounding housing 200 to form the reservoir 120. When the chain 100 of the chainsaw 10 moves along the guide plate 110, different positions of the chain 100 pass through the position of the reservoir 120 sequentially so that the chain 100 can adhere to the liquid in the reservoir 120, thereby lubricating or cooling the chain 100 by the liquid.

The second opening 41132 communicates with the oil can 630 through the second oil passage 440. Specifically, the second opening 41132 is provided with an oil suction port 460 for sucking the liquid from the oil can 630 into the liquid pump 410. Driven by the liquid pump 410, the lubricating oil or water stored in the oil can 630 can enter the liquid pump 410 through the second oil passage 440 and enter the reservoir 120 at the output assembly through the first oil passage 430. When the output assembly works, the liquid in the reservoir 120 can lubricate or cool the output assembly or have another effect.

In some more specific examples, the oil can 630 is disposed within the grip 210, that is, the oil can 630 is disposed in a mounting cavity corresponding to the grip 210. The oil can 630 is disposed in the mounting cavity corresponding to the grip 210 so that not only can the mounting cavity corresponding to the grip 210 be utilized and the weight of the power tool be more balanced, but also the oil can 630 can be closer to the liquid pump 410 disposed within the grip 210 and the required length of the second oil passage 440 can be effectively reduced. In an example, the oil can 630 is integrated on an inner wall surface of the housing 200 so that the oil can 630 can be formed while the housing 200 is manufactured, thereby avoiding the phenomenon of an accidental detachment of the oil can 630. In an example, the oil can 630 is at least partially disposed on the front side of the first motor 300.

In some examples, the liquid pump 410 may be driven by the first motor 300, that is, the first motor 300 is connected to both the output assembly and the liquid pump 410 through transmission assemblies to simultaneously drive the output assembly and the liquid pump 410. Optionally, a gear mechanism, a sprocket mechanism, or the like may be selected as a transmission assembly as required.

In some examples, the power tool further includes a second motor 420, a first motor shaft of the second motor 420 is directly connected to the liquid pump 410, and the second motor 420 is used for driving the liquid pump 410 to operate. Compared with the first motor 300 for simultaneously driving the output assembly and the liquid pump 410, the independent second motor 420 is additionally disposed as a piece for driving the liquid pump 410 so that not only can a transmission assembly with a complex structure be omitted, but also it is easier to dispose the second motor 420 in the mounting cavity of the housing 200 since the second motor 420 occupies a small space, facilitating the full use of the space in the housing 200 and the miniaturization of the power tool. Specifically, as shown in FIG. 8, an end of the second motor 420 facing away from the liquid pump 410 is provided with a first electrode 421 and a second electrode 422, where the first electrode 421 and the second electrode 422 are electrically connected to a positive electrode and a negative electrode of a power piece, respectively. Still referring to FIGS. 1 to 3, the power tool further includes a battery pack coupling portion 610 for coupling a battery pack. The battery pack, as the power piece, is electrically connected to the first electrode 421 and the second electrode 422. Optionally, the battery pack is detachably connected to the battery pack coupling portion 610 to be convenient to detach for replacement or charging. The battery pack can supply power to the first motor 300 in addition to the second motor 420. In addition to the use of the battery pack as the power piece, the first motor 300 and the second motor 420 may be directly connected to external mains electricity through a power line, thereby achieving power supply.

In an example, still referring to FIGS. 2 and 3, a circuit board 620 is disposed at the battery pack coupling portion 610, and the circuit board 620 is at least partially disposed within the battery pack coupling portion 610. In an example, the circuit board 620 is entirely disposed within the battery pack coupling portion 610. The circuit board 620 may be used for controlling the second motor 420. Specifically, an insertion cavity is formed in the battery pack coupling portion 610, and the circuit board 620 is inserted into the insertion cavity. The direction in which the battery pack is inserted into the battery pack coupling portion 610 is defined as a first direction, and the direction in which the circuit board 620 is inserted into the insertion cavity is defined as a second direction. In some examples, the first direction is parallel to the second direction. In some other examples, the first direction and the second direction are arranged at an angle that may be flexibly set according to a space in the battery pack coupling portion 610 and is not specifically limited herein.

The circuit board 620 may also be used for controlling the first motor 300. One circuit board 620 is used for controlling both the first motor 300 and the second motor 420 so that one circuit board 620 can be omitted, reducing a cost and an occupied space in the housing 200. In this example, the circuit board 620 may be a centralized or distributed controller. For example, the controller may be one separate single-chip microcomputer or may be composed of multiple distributed single-chip microcomputers. The single-chip microcomputer can run control programs to control the first motor 300 and the second motor 420 to implement their functions.

In some more specific examples, as shown in FIG. 2, the second motor 420 is disposed within the grip 210. The second motor 420 is disposed in the mounting cavity corresponding to the grip 210 so that a more reasonable layout can be achieved, not only can the mounting cavity corresponding to the grip 210 be utilized but also the weight of the power tool can be more balanced, and the user uses the power tool with less labor.

Still referring to FIG. 2, in an example, the liquid pump 410 is disposed within the grip 210, that is, the liquid pump 410 is disposed in the mounting cavity corresponding to the grip 210. Both the liquid pump 410 and the second motor 420 are disposed in the mounting cavity corresponding to the grip 210, thereby facilitating a direct connection between the second motor 420 and the liquid pump 410 and avoiding a need to dispose a transmission structure for power transmission between the second motor 420 and the liquid pump 410.

In an example, along the operation direction of the power tool, the liquid pump 410 and the second motor 420 are arranged substantially in a front and rear direction. In this manner, the space of the mounting cavity in the grip 210 can be fully utilized, and the liquid pump 410 and the second motor 420 are easy to assemble. In an example, along the operation direction of the power tool, the liquid pump 410 is disposed on the front side of the second motor 420. In an example, the liquid pump 410 and the second motor 420 both extend along a preset direction at a preset angle relative to a horizontal direction. It is to be noted that the preset angle here may be an acute angle, an obtuse angle, or a right angle. In an example, the liquid pump 410 and the second motor 420 may both extend along a vertical direction or along the horizontal direction. In an example, the liquid pump 410 may be disposed on the left or right side of the second motor 420.

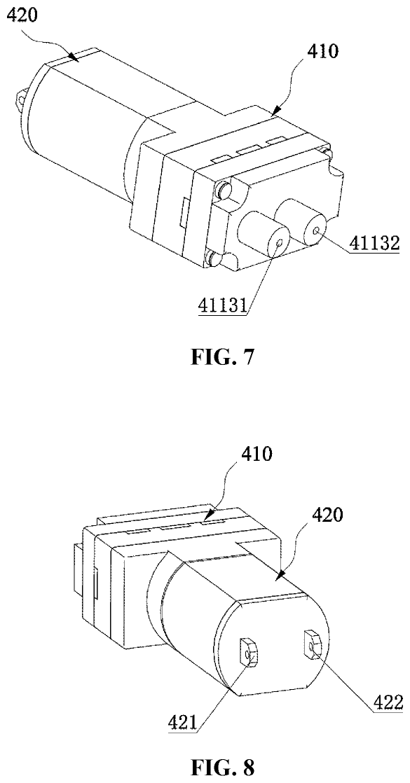

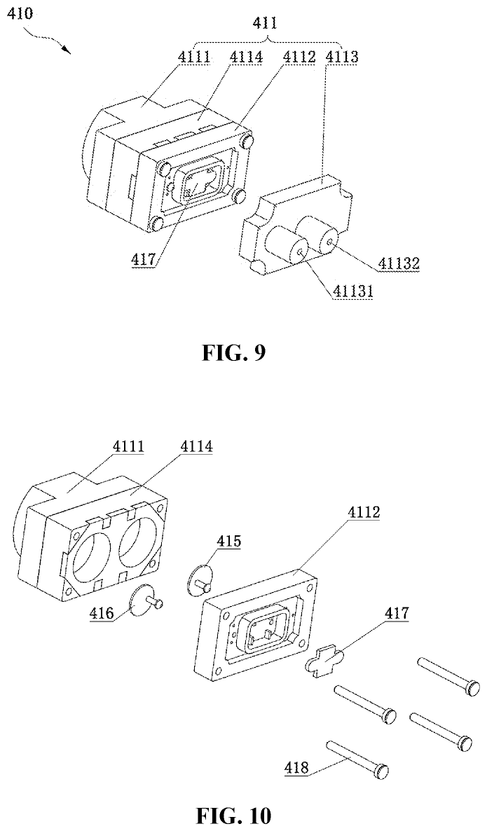

The specific structure of the liquid pump 410 is described below with reference to FIGS. 7 to 15.

As shown in FIGS. 7 to 15, the liquid pump 410 includes a pump housing 411, a soft cover 412, an oscillating member 413, an eccentric member 414, a first soft disk 415, a second soft disk 416, a flexible barrier pad 417, and connectors 418.

The pump housing 411 is a main protective component and mounting component of the liquid pump 410, and the soft cover 412, the oscillating member 413, the eccentric member 414, the first soft disk 415, the second soft disk 416, and the flexible barrier pad 417 are all disposed in the pump housing 411. In this example, since relatively many components need to be mounted in the pump housing 411, the pump housing 411 is configured to be a split structure to facilitate assembly and positioning, and a detachable connection is implemented through multiple connectors 418. In an example, the connectors 418 are screws, four connectors 418 are provided, the pump housing 411 is cubic, and the four connectors 418 are connected at four corners of the pump housing 411, separately.

Specifically, as shown in FIGS. 9, 11, and 12, the pump housing 411 includes a first housing 4111, a second housing 4112, and a third housing 4113 connected in sequence. A first chamber is formed between the first housing 4111 and the second housing 4112, and a second chamber is formed between the second housing 4112 and the third housing 4113. It is to be noted that the first chamber and the second chamber can communicate only through holes on the second housing 4112, where the holes here refer to a first through hole 41123 and a second through hole 41124 shown in FIG. 14, which penetrate through the second housing 4112. The soft cover 412, the oscillating member 413, the eccentric member 414, the first soft disk 415, and the second soft disk 416 are all disposed in the first chamber. The flexible barrier pad 417 is disposed in the second chamber. The third housing 4113 is provided with the first opening 41131 and the second opening 41132.

More specifically, the soft cover 412 is made of a flexible material and is deformable to compress the liquid. In the liquid pump 410 of the power tool, the soft cover 412 deforms to compress the liquid. Since the soft cover 412 is made of the flexible material, sealability is improved and oil leakage is avoided. In this example, the soft cover 412 is made of soft rubber. Another material may be selected for the soft cover 412 according to an actual situation.

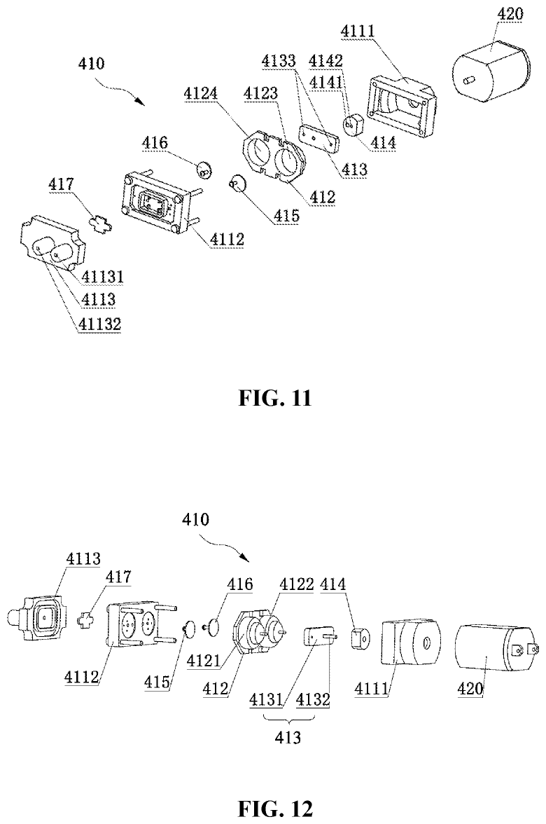

Still referring to FIGS. 11 and 12, the soft cover 412 includes a first soft cover portion 4121 and a second soft cover portion 4122 which are connected to each other, and both the first soft cover portion 4121 and the second soft cover portion 4122 are bowl-shaped and can deform alternately under the action of an external force. A first compression cavity 4123 is formed between the second housing 4112 and the first soft cover portion 4121, and a second compression cavity 4124 is formed between the second housing 4112 and the second soft cover portion 4122. The liquid pump 410 is provided with a first flow channel penetrating through the second housing 4112 and making the first opening 41131 communicate with the first compression cavity 4123 and a second flow channel penetrating through the second housing 4112 and making the second opening 41132 communicate with the second compression cavity 4124. It is to be noted that the first through hole 41123 is part of the first flow channel, and the second through hole 41124 is part of the second flow channel.

The first soft cover portion 4121 forms the first compression cavity 4123, the second soft cover portion 4122 forms the second compression cavity 4124, and the liquid in the first compression cavity 4123 and the second compression cavity 4124 can be compressed out or sucked in.

It is to be noted that in this example, the first soft cover portion 4121 and the second soft cover portion 4122 form a structure similar to a seesaw. Under the action of the external force, one of the first soft cover portion 4121 and the second soft cover portion 4122 is compressed, and the other of the first soft cover portion 4121 and the second soft cover portion 4122 is restored to the original bowl shape. When the first soft cover portion 4121 deforms, the first compression cavity 4123 is compressed, a volume therein becomes smaller, and pressure therein increases so that the first flow channel is conducted and the second flow channel is blocked. When the second soft cover portion 4122 deforms, the second compression cavity 4124 is compressed, a volume therein becomes smaller, and pressure therein increases so that the second flow channel is conducted and the first flow channel is blocked. Additionally, it is to be noted that when one of the first soft cover portion 4121 and the second soft cover portion 4122 deforms, the compression cavity corresponding to the deformed soft cover portion 412 has a smaller volume and is in a positive pressure state, and the compression cavity corresponding to the soft cover portion 412 restored to the original bowl shape has a larger volume and is in a negative pressure state.

To limit and mount the soft cover 412, still referring to FIG. 9, the pump housing 411 further includes a fourth housing 4114 disposed between the first housing 4111 and the second housing 4112, where two circular through holes penetrate through the fourth housing 4114, and the first soft cover portion 4121 and the second soft cover portion 4122 are disposed in the two circular through holes, separately. It is to be explained that the fourth housing 4114 will not limit the oscillation and deformation of the first soft cover portion 4121 and the second soft cover 4122.

To drive the soft cover 412 to oscillate, still referring to FIGS. 11 and 12, the liquid pump 410 further includes the oscillating member 413 and the eccentric member 414, two ends of the oscillating member 413 are connected to the first soft cover portion 4121 and the second soft cover portion 4122 separately, and the eccentric member 414 is connected to a side of the oscillating member 413 facing away from the soft cover 412 and can perform an eccentric motion under the action of the external force. In some examples, the eccentric member 414 is driven by the first motor 300 to perform the eccentric motion. In some parallel examples, the eccentric member 414 is driven by the second motor 420 to perform the eccentric motion.

As shown in FIGS. 11 and 12, the oscillating member 413 includes an oscillating plate 4131 and a positioning shaft 4132 connected perpendicularly, the positioning shaft 4132 is connected to the middle of the oscillating plate 4131, the oscillating plate 4131 is provided with one third connecting hole 4133 on each of two sides of the positioning shaft 4132, and two third connecting holes 4133 are used for a connecting shaft of the first soft cover portion 4121 and a connecting shaft of the second soft cover portion 4122 to pass through, separately. The eccentric member 414 is provided with a first connecting hole 4141 and a second connecting hole 4142, where the first connecting hole 4141 is used for an output shaft 421 of the second motor 420 to pass through, and the second connecting hole 4142 is used for the positioning shaft 4132 of the oscillating member 413 in FIG. 12 to pass through.

To improve the sealability of a first sealed cavity and a second sealed cavity, the liquid pump 410 further includes the first soft disk 415 and the second soft disk 416. Both the first soft disk 415 and the second soft disk 416 are disposed on a side of the second housing 4112 facing the soft cover 412, the first soft disk 415 seals at least part of the first compression cavity 4123 and is staggered from the first flow channel, and the second soft disk 416 seals at least part of the second compression cavity 4124 and is staggered from the second flow channel. In this manner, in a non-working state, the first soft disk 415 and the second soft disk 416 seal passages through which the liquid flows, that is, the first flow channel and the second flow channel are sealed so that the leakage of the liquid does not easily occur.

To mount the first soft disk 415 and the second soft disk 416, the second housing 4112 is provided with at least two insertion holes, the first soft disk 415 and the second soft disk 416 are each provided with at least one insertion column, and the insertion column is inserted into an insertion hole so that the first soft disk 415 is fixed relative to the second housing 4112, and the second soft disk 416 is fixed relative to the second housing 4112.

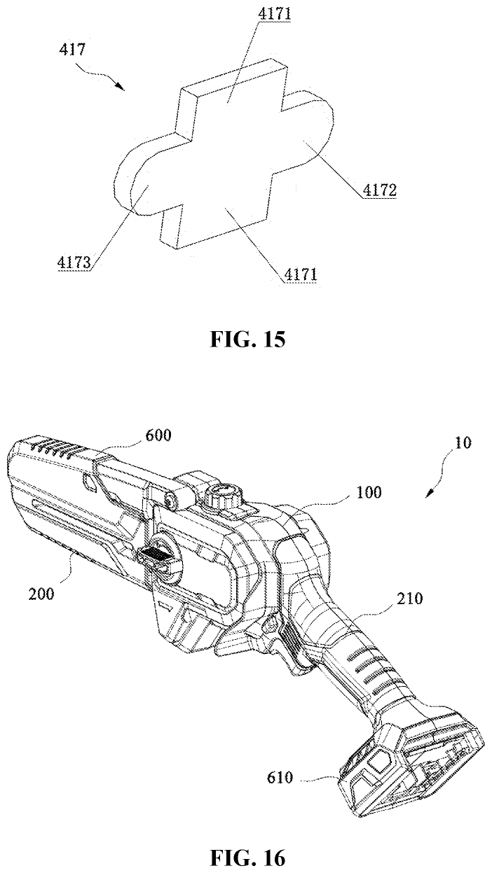

To alternately open and close the first flow channel and the second flow channel, the liquid pump 410 is further provided with the flexible barrier pad 417. As shown in FIG. 15, the flexible barrier pad 417 includes a first flexible blocking portion 4172, two fixing portions 4171, and a second flexible blocking portion 4173. In this example, the first flexible blocking portion 4172, the two fixing portions 4171, and the second flexible blocking portion 4173 are cross-shaped.

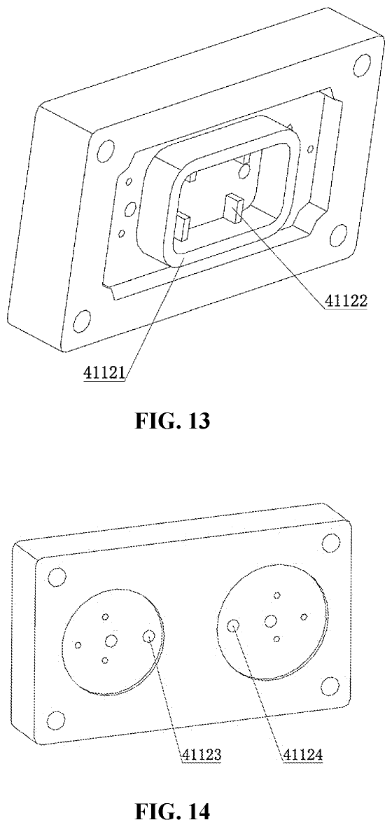

The two fixing portions 4171 are fixed to the second housing 4112. Specifically, as shown in FIG. 13, four limiting blocks 41122 are disposed on an end surface of the second housing 4112 facing the third housing 4113, the four limiting blocks 41122 are arranged in a rectangular array, one limiting space is formed between two limiting blocks 41122 in the same row, the two fixing portions 4171 are limited in two limiting spaces formed by two rows of limiting blocks 41122 separately, the first flexible blocking portion 4172 passes through a gap between two limiting blocks 41122 in one column and is disposed on a side of the four limiting blocks 41122, and the second flexible blocking portion 4173 passes through a gap between two limiting blocks 41122 in the other column and is disposed on the other side of the four limiting blocks 41122. Still referring to FIG. 13, a ring-shaped rib 41121 is provided on an outer side of the four limiting blocks 41122, and the four limiting blocks 41122 and the flexible barrier pad 417 are all disposed within the ring-shaped rib 41121.

The first flexible blocking portion 4172 may selectively open and close the first flow channel. Specifically, the first through hole 41123 is disposed at a position of the second housing 4112 directly facing the first flexible blocking portion 4172, and the first flexible blocking portion 4172 blocks or opens the first through hole 41123 to block or conduct the first flow channel. The second flexible blocking portion 4173 may selectively open and close the second flow channel. Specifically, the second through hole 41124 is disposed at a position of the second housing 4112 directly facing the second flexible blocking portion 4173, and the second flexible blocking portion 4173 blocks or opens the second through hole 41124 to block or conduct the second flow channel.

A working process of the liquid pump 410 is specifically described below.

The second motor 420 is powered on and drives the eccentric member 414 to perform the eccentric motion, the eccentric member 414 can drive, during rotation, the oscillating member 413 to oscillate, and the oscillating member 413 alternately compresses the first soft cover portion 4121 and the second soft cover portion 4122 of the soft cover 412 during oscillation so that the first compression cavity 4123 and the second compression cavity 4124 are alternately compressed and reset, the compressed compression cavity is in the positive pressure state, and the reset compression cavity is in the negative pressure state.

When the first compression cavity 4123 is in the positive pressure state and the second compression cavity 4124 is in the negative pressure state, gas in the first compression cavity 4123 passes through the first through hole 41123 of the second housing 4112 and blows the first flexible blocking portion 4172 of the flexible barrier pad 417 so that the first flexible blocking portion 4172 is released from blocking the first through hole 41123. At this time, the first flow channel is conducted, and the liquid in the liquid pump 410 can be pressed through the first oil passage 430 into the reservoir 120 formed by the output assembly. Since the second compression cavity 4124 is in the negative pressure state, the second flexible blocking portion 4173 of the flexible barrier pad 417 always blocks the second through hole 41124 under the action of external air pressure, and the second flow channel is blocked.

When the second compression cavity 4124 is in the positive pressure state and the first compression cavity 4123 is in the negative pressure state, gas in the second compression cavity 4124 passes through the second through hole 41124 of the second housing 4112 and blows the second flexible blocking portion 4173 of the flexible barrier pad 417 so that the second flexible blocking portion 4173 is released from blocking the second through hole 41124. At this time, the second flow channel is conducted, and the liquid in the oil can 630 can be sucked into the liquid pump 410. Since the first compression cavity 4123 is in the negative pressure state, the first flexible blocking portion 4172 of the flexible barrier pad 417 always blocks the first through hole 41123 under the action of external air pressure, and the first flow channel is blocked.

In an example, still referring to FIG. 1, the power tool further includes a switch 650 disposed below the housing, and the user may flexibly operate the switch 650 when holding the grip 210 to power on or power off the whole power tool. Still referring to FIG. 1, the power tool further includes a shield 640 disposed above the output assembly to prevent debris generated during operation of the output assembly from flying arbitrarily, thereby improving the safety of use of the power tool.

It is to be noted that the second motor 420 and the liquid pump 410 are integrated into the liquid pump assembly 400, and the second motor 420 and the liquid pump 410 in the liquid pump assembly 400 may mate with each other as described in this example, or a transmission structure may be added between the second motor 420 and the liquid pump 410 so that the second motor 420 and the liquid pump 410 may be spaced apart by a distance. Therefore, as shown in FIG. 3, the liquid pump assembly 400 may be disposed on a side of the inside of the grip 210 facing the battery pack coupling portion 610, or the second motor 420 and the liquid pump 410 may be disposed on two sides separately in the grip 210.

In an example, the liquid pump assembly 400 is disposed between the switch 650 and the circuit board 620. In an example, the liquid pump assembly 400 is disposed between the switch 650 and the battery pack coupling portion 610. In an example, the liquid pump assembly 400 is disposed between the first motor 300 and the battery pack coupling portion 610. In an example, the liquid pump assembly 400 is disposed between the first motor 300 and the circuit board 620. In an example, at least part of the liquid pump assembly 400 may be disposed in the battery pack coupling portion 610.

In this example, the circuit board 620 controls the first motor 300 and the second motor 420. In an example, the liquid pump assembly 400 may be controlled by a separate circuit board distinguished from the circuit board 620.

Based on the preceding example, a new example provides a chainsaw 10. The chainsaw 10 includes a chain 100, a guide plate 110, a housing 200, a first motor 300, a liquid pump assembly 400, a battery pack coupling portion 610, a circuit board 620, an oil can 630, a shield 640, and a switch 650. The chain 100 implements a cutting operation, the guide plate 110 extends along a front and rear direction and is used for guiding the chain 100, the first motor 300 is used for driving the chain 100 to perform the cutting operation, and the liquid pump assembly 400 is used for releasing a liquid to lubricate or cool the chain 100.

It is to be noted that in this example, the chain 100, as an output assembly of the chainsaw 10, can rotate along a circumferential direction of the guide plate 110 to cut a target workpiece. Other components (such as the liquid pump assembly 400) than the output assembly are the same as the corresponding components in example one and thus are not repeated here.

As shown in FIG. 4, a new example provides a power tool including an output assembly 480 for implementing an operation, a housing 200, and a drive assembly 470. When the power tool is a chainsaw 10, the output assembly 480 is a chain. When the power tool is a circular saw or the like, the output assembly is a saw blade. The housing 200 is formed with a grip 210 for an operator to hold. Specific details of the grip 210 are the same as those of example one and are not repeated here.

The drive assembly 470 includes a liquid pump 410 and a motor for driving the liquid pump 410. The drive assembly 470 is used for releasing or sucking a liquid. In an example, the power tool further includes an oil can 630. It is to be noted that the oil can 630 is a liquid storage device, and the oil can 630 may be used for accommodating lubricating oil or another liquid such as water. In an example, the drive assembly 470 is used for lubricating or cooling the output assembly 480.

The drive assembly 470 is at least partially disposed within the grip 210. It is to be noted that when a transmission structure is included between the motor for driving the liquid pump 410 and the liquid pump 410, the drive assembly 470 further includes the transmission structure between the liquid pump 410 and the motor for driving the liquid pump 410.

In an example, a first motor 300 drives the liquid pump 410, and the first motor 300 and the liquid pump 410 may be connected by a transmission structure or the liquid pump 410 may be directly driven by the first motor 300. In an example, a second motor 420 drives the liquid pump 410, and the second motor 420 and the liquid pump 410 may be connected by a transmission structure or the liquid pump 410 may be directly driven by the second motor 420. The liquid pump 410 may be driven by a combination of multiple motors.

According to the technical solutions disclosed in the present application, in one aspect, compared with the transmission assembly disposed between the first motor and the liquid pump, the second motor drives the liquid pump in the present application, two motors are independently arranged, and the second motor and the liquid pump are integrated so that it is convenient to independently control the liquid pump to release the liquid by the second motor. In another aspect, in the power tool, at least part of the liquid pump assembly is disposed inside the grip formed by the housing so that the space inside the grip is reasonably utilized, and a space occupied by the transmission structure between the first motor and the liquid pump is saved, thereby facilitating the miniaturization of the power tool.

FIGS. 16 to 19 show another example of the present application.

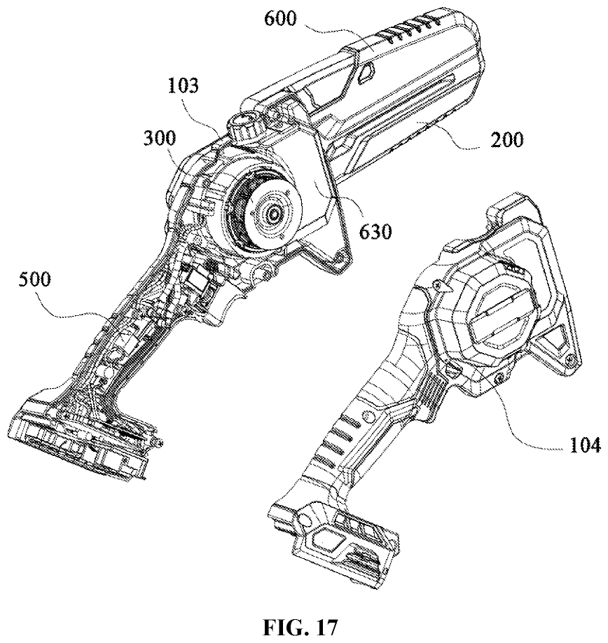

This example provides a chainsaw 10 for a user to hold with a single hand to perform a cutting operation. As shown in FIGS. 16 and 17, the chainsaw 10 includes a housing 100, an output assembly 200, a first motor 300, an oil can 630, and a liquid pump assembly 500. The housing 100 is formed with a grip 210 for the user to hold. The output assembly 200 is connected to the housing 100 and used for implementing the cutting operation. The output assembly 200 includes a guide plate 201 and a saw chain 202 disposed around the guide plate 201. The first motor 300 is used for supplying power for the saw chain 202 to move along the guide plate 201 to perform the cutting operation. The oil can 630 is used for storing lubricating oil, and the liquid pump assembly 500 includes an oil tube and a squeezing piece, where the oil tube includes an oil inlet end communicating with the oil can 630 and an oil outlet end extending to the output assembly 200, and the squeezing piece can rotate about a first straight line to squeeze the oil tube into deformation so that the lubricating oil within the oil can 630 is transported to the saw chain 202 through the oil tube.

The chainsaw 10 uses the oil tube and the squeezing piece as the liquid pump assembly 500, and the squeezing piece squeezes the oil tube into deformation so that negative pressure is generated within the oil tube, where the negative pressure can supply power for the lubricating oil to flow. Compared with a diaphragm pump for pumping oil, which causes a relatively large volume of the chainsaw, the liquid pump assembly 500 in the example of the present application is small in volume and occupies a small space inside the chainsaw 10, thereby facilitating the miniaturization of the chainsaw 10. Moreover, compared with a plunger pump for pumping oil, which easily causes oil leakage of the chainsaw, the liquid pump assembly 500 in the example of the present application can achieve stable oil output so that the oil leakage is not easy to occur.

As shown in FIG. 17, the housing 100 is a split structure, a first housing half 103 and a second housing half 104 are spliced into the housing 100, and an inner wall surface of the first housing half 103 and an inner wall surface of the second housing half 104 surround an accommodation space. The housing 100 into which the first housing half 103 and the second housing half 104 are spliced is manufactured with low difficulty and facilitates the assembly of other components inside and outside the housing 100. In other examples of the present application, an upper housing and a lower housing or more housing halves may be spliced into the housing 100.

In some examples, as shown in FIGS. 16 and 17, in an operation direction of a power tool, the grip 210 is disposed behind the output assembly, the grip 210 has a cylindrical structure, and a cross-section perpendicular to the operation direction is substantially elliptical, and an extension direction of the grip 210 and an extension direction of the output assembly 200 are arranged at an angle, for example, at an obtuse angle greater than 90° and less than 180°. In other examples, the angle between the extension direction of the grip 210 and the extension direction of the output assembly 200 may be set to 90° as required, that is, the grip 210 is perpendicular to the output assembly 200. Alternatively, the angle between the extension direction of the grip 210 and the extension direction of the output assembly 200 may be set to 180° as required, that is, the grip 210 is collinear with the output assembly 200. The shape of the grip 210 may be adjusted as required so long as the grip 210 is convenient for the user to hold to operate the chainsaw 10.

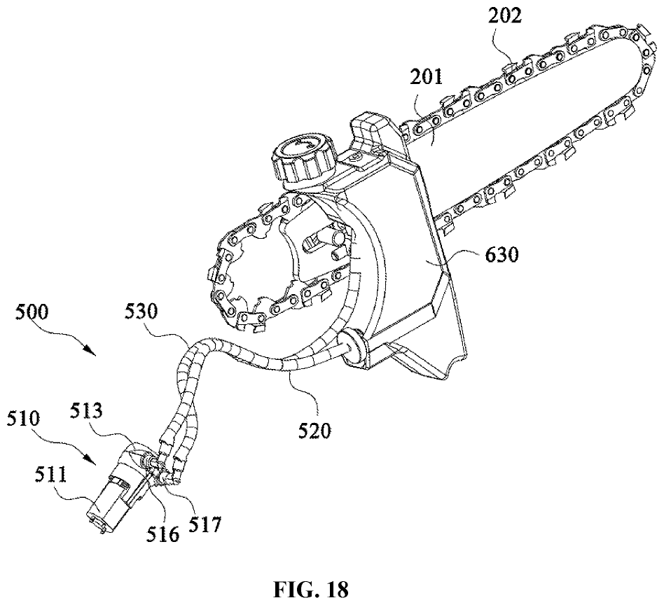

Still referring to FIG. 18, the guide plate 201 of the output assembly 200 is mounted at a front end of the housing 100 and disposed vertically, and the guide plate 201 extends substantially along a front and rear direction. The saw chain 202 is sleeved on the guide plate 201 and can be guided by the guide plate 201 to move around the guide plate 201, and the saw chain 202 moves in a vertical plane to perform the cutting operation on a workpiece to be cut. It is to be noted that a region where the output assembly 200 is located is a cutting region of the chainsaw 10, and the vertical plane where the saw chain 202 is located is a cutting plane of the chainsaw 10. In some examples, the output assembly 200 is connected to one side of the housing 100, for example, connected to the left side of the first housing half 103 or the right side of the second housing half 104.

As shown in FIG. 18, the liquid pump assembly 500 further includes an oil inlet tube 520 and a lubricating oil tube 530, where an end of the oil inlet tube 520 communicates with the oil can 630, and the other end of the oil inlet tube 520 communicates with an oil inlet of the oil tube. An oil inlet end of the lubricating oil tube 530 communicates with an oil outlet of the oil tube, and an oil outlet end of the lubricating oil tube 530 extends to the saw chain 202. In some examples, a reservoir is disposed at the guide plate 201, the oil outlet end of the lubricating oil tube 530 is disposed in the reservoir, the reservoir is formed by a sealing ring disposed on the guide plate 201, the sealing ring abuts against the guide plate 201, and part of the sealing ring is embedded into the housing 100 and part of the sealing ring is higher than the surrounding housing 100 to form the reservoir. When the saw chain 202 moves along the guide plate 201, different positions of the saw chain 202 pass through the position of the reservoir sequentially so that the saw chain 202 can adhere to a liquid in the reservoir, thereby lubricating or cooling the saw chain 202 by the liquid.

The first motor 300 is disposed within the accommodation space in the housing 100, and an output shaft of the first motor 300 is disposed substantially along a horizontal direction, that is, the output shaft of the first motor 300 extends in a direction substantially perpendicular to the cutting plane of the output assembly 200. The output shaft of the first motor 300 faces the side of the output assembly 200. When the output assembly 200 is connected to the left side of the first housing half 103, an output end of the output shaft is disposed on the left side of the first motor 300. In some examples, the first motor 300 employs a first servomotor or a first stepper motor. A fan is connected to the other end of the output shaft of the first motor 300, where the fan can synchronously rotate with the output shaft of the first motor 300 to achieve heat dissipation of the first motor 300.

In some examples, the chainsaw 10 further includes a transmission assembly connected between the output shaft of the first motor 300 and the saw chain 202. Specifically, the transmission assembly is a gearbox including a casing, a cover, and a planet gear mechanism, where the planet gear mechanism is disposed in a space defined by the casing and the cover and includes an outer ring gear, a planet carrier, planet gears, and a sun gear, each planet gear is rotatably connected to the planet carrier by a pin shaft, the sun gear meshes with the planet gears, the output shaft of the first motor 300 is connected to the sun gear, the outer ring gear is sleeved outside the planet carrier and meshes with the planet gears, a planet carrier shaft of the planet carrier penetrates through the cover and is connected to a sprocket, and the sprocket meshes with the saw chain 202. The output shaft of the first motor 300 can output torque and a rotational speed to the sprocket under the deceleration action of the transmission assembly, the rotation of the sprocket can drive the saw chain 202 to move, and the saw chain 202 in motion can perform the cutting operation on the workpiece to be cut.

In some examples, the first motor 300 is drivingly connected to the squeezing piece and used for driving the squeezing piece to rotate about the first straight line. That is to say, the first motor 300, as a unique power source of the single-hand saw chain 202, can drive the output assembly 200 and the squeezing piece to simultaneously act.

The squeezing piece includes a sprocket mechanism and a squeezing roller, where the sprocket mechanism includes a driving wheel, a driven wheel, and a chain, the driving wheel is connected to the output shaft of the first motor 300, the driven wheel is rotatably connected in the housing 100, the chain is sleeved on the driving wheel and the driven wheel, an end of the squeezing roller is connected to the chain, and the other end of the squeezing roller is pressed against the oil tube. In some examples, multiple squeezing rollers are provided and spaced apart in an axial direction of the oil tube.

In some examples, the chainsaw 10 further includes a second motor, where the second motor is drivingly connected to the squeezing piece and used for driving the squeezing piece to rotate about the first straight line. Compared with the first motor 300 for simultaneously driving the output assembly 200 and the squeezing piece, the independent second motor is additionally disposed as a piece for driving the squeezing piece so that not only can a transmission assembly with a complex structure be omitted, but also it is easier to dispose the second motor in the housing 100 since the second motor occupies a small space, facilitating the full use of the space in the housing 100 and the miniaturization of the power tool.

Still referring to FIG. 16, the power tool further includes a battery pack coupling portion 610 and a battery pack (not shown), where the battery pack coupling portion 610 is formed at an end of the grip 210 facing away from the output assembly 200 and used for coupling the battery pack, and the battery pack is used for supplying electrical energy to all electric components of the chainsaw 10. Optionally, the battery pack is detachably connected to the battery pack coupling portion 610 to be convenient to detach for replacement or charging.

In some examples, the battery pack is detachably connected to the battery pack coupling portion 610, that is, the battery pack is connected outside the grip 210. In some examples, the battery pack is disposed in an accommodation space corresponding to the grip 210. The chainsaw 10 further includes a trigger for the user to operate. When the user presses the trigger, the first motor 300 is electrically connected to the battery pack. In some examples, the trigger is further configured to adjust a rotational speed of the first motor 300.

A circuit board for controlling the second motor is disposed at the battery pack coupling portion 610. The circuit board is at least partially disposed within the battery pack coupling portion 610. In an example, the circuit board is entirely disposed within the battery pack coupling portion 610. Specifically, an insertion cavity is formed in the battery pack coupling portion 610, and the circuit board is inserted into the insertion cavity. The circuit board may also be used for controlling the first motor 300. One circuit board is used for controlling both the first motor 300 and the second motor so that one circuit board can be omitted, reducing a cost and an occupied space in the housing 100. In this example, the circuit board may be a centralized or distributed controller. For example, the controller may be one separate single-chip microcomputer or may be composed of multiple distributed single-chip microcomputers. The single-chip microcomputer can run control programs to control the first motor 300 and the second motor to implement their functions.

In some more specific examples, as shown in the figures, the second motor is disposed within the grip 210. The second motor is disposed in a mounting cavity corresponding to the grip 210 so that a more reasonable layout can be achieved, not only can the mounting cavity corresponding to the grip 210 be utilized but also the weight of the power tool can be more balanced, and the user uses the power tool with less labor.

Still referring to FIG. 17, in an example, the liquid pump assembly 500 is disposed within the grip 210, that is, the liquid pump assembly 500 is disposed in the mounting cavity corresponding to the grip 210. Both the liquid pump assembly 500 and the second motor are disposed in the mounting cavity corresponding to the grip 210, thereby facilitating a direct connection between the second motor and the liquid pump assembly 500 and avoiding a need to dispose a transmission structure for power transmission between the second motor and the liquid pump assembly 500.

In an example, along the operation direction of the power tool, the liquid pump assembly 500 and the second motor are arranged substantially in the front and rear direction. In this manner, the space of the mounting cavity in the grip 210 can be fully utilized, and the liquid pump assembly 500 and the second motor are easy to assemble. In an example, along the operation direction of the power tool, the liquid pump assembly 500 is disposed on the front side of the second motor. In an example, the liquid pump assembly 500 and the second motor both extend along a preset direction at a preset angle relative to the horizontal direction. It is to be noted that the preset angle here may be an acute angle, an obtuse angle, or a right angle. In an example, the liquid pump assembly 500 and the second motor may both extend along a vertical direction or along the horizontal direction. In an example, the liquid pump assembly 500 may be disposed on the left or right side of the second motor.

Still referring to FIGS. 16 and 17, the output assembly 200 further includes a lampshade 600 fixed above the guide plate 201 and the saw chain 202 and used for protecting the single-hand saw chain 202. A lighting mechanism is disposed on the lampshade 600. The cutting region is illuminated by the lighting mechanism so that the user can clearly acquire a cutting progress and control a cutting direction, thereby improving cutting quality.

In some examples, the lampshade 600 is transparent and made of a transparent material. An outer side surface of the lampshade 600 may be sanded or otherwise treated to block light. An inner sidewall of the lampshade 600 is inclined to transmit light towards the guide plate 201, or a light guide column is disposed in the lampshade 600 to guide light to above the saw chain 202, thereby enhancing a light intensity at the saw chain 202 and improving a visual effect.

In some examples, the lighting mechanism is a light-emitting diode (LED) lamp directly controlled by a control mechanism of the chainsaw 10. Under the control of the control mechanism, the LED lamp may be configured to be lit ahead of time. In this example, the control mechanism may be a centralized or distributed controller. For example, the controller may be one separate single-chip microcomputer or may be composed of multiple distributed single-chip microcomputers. The single-chip microcomputer can run control programs to control the LED lamp to implement its function. It is to be noted that the control mechanism and the preceding circuit board may be integrated or may be two independent mechanisms. In addition to the LED lamp, the lighting mechanism may employ a halogen lamp, a high-pressure sodium lamp, a low-pressure sodium lamp, or another lamp capable of implementing a lighting operation.

In some examples, the lighting mechanism is connected to the battery pack through a wire, and the battery pack supplies electrical energy to the lighting mechanism. In some other examples, the chainsaw 10 may also be provided with a solar cell panel on an outer wall surface of the lampshade 600, the lighting mechanism is electrically connected to the solar cell panel, and the lighting mechanism is powered by the solar cell panel. In addition to the lighting mechanism, the solar cell panel may supply power to other electric components of the chainsaw 10, and the solar cell panel may even completely replace the battery pack if enough electrical energy is supplied.

Generally, the lighting mechanism is disposed on the lampshade 600 and rotates synchronously with the lampshade 600 to facilitate maintenance and replacement of the lighting mechanism. In other examples, the lighting mechanism may be fixedly disposed on the housing 100 so as not to rotate synchronously with the lampshade 600.

As shown in FIGS. 16 to 19, a new example provides a chainsaw 10 including a housing 100, an output assembly 200, a first motor 300, an oil can 630, and a liquid pump assembly 500, where the housing 100 is formed with a grip 210 for a user to hold; the output assembly 200 is connected to the housing 100 and includes a guide plate 201 and a saw chain 202 disposed around the guide plate 201; the first motor 300 is used for supplying power for the saw chain 202 to move along the guide plate 201 to perform a cutting operation; the oil can 630 is used for storing lubricating oil; and the liquid pump assembly 500 includes a peristaltic pump 510, where the peristaltic pump 510 supplies power for the lubricating oil to flow so that a liquid within the oil can 630 can be transported to the saw chain 202, and at least part of the peristaltic pump 510 is disposed within the grip 210.

The chainsaw 10 uses the peristaltic pump 510 as a power member of the liquid pump assembly 500. The peristaltic pump 510 is relatively small in volume, facilitating a compact structure of the chainsaw 10 and the miniaturization of the chainsaw 10. The use of the peristaltic pump 510 can solve the problem of unstable oil pumps due to a difficulty in controlling a motion gap and an abrasion problem of an original mechanical pump. The peristaltic pump 510 has good structural sealability and good oil pump stability, oil leakage or oil shortage is not easy to occur, and the user has relatively good user experience. It is to be noted that a difference between the chainsaw 10 using the peristaltic pump 510 as the liquid pump assembly 500 and the chainsaw 10 using the squeezing piece and a hose 515 as the liquid pump assembly 500 only lies in the peristaltic pump 510, and other structures are the same and are not repeated here.

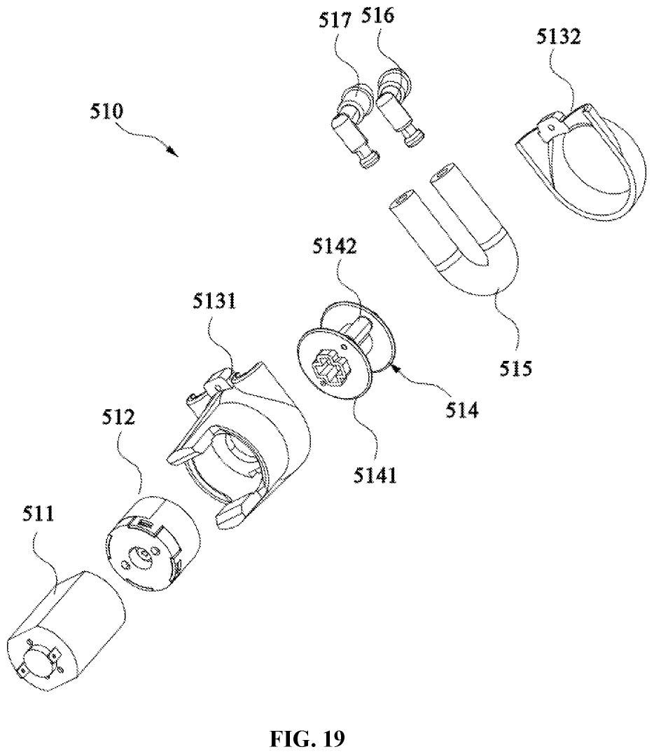

The specific structure of the peristaltic pump 510 is described below with reference to FIGS. 18 and 19.

As shown in FIG. 18, the liquid pump assembly 500 further includes an oil inlet tube 520 and a lubricating oil tube 530, where an end of the oil inlet tube 520 communicates with the oil can 630, and the other end of the oil inlet tube 520 communicates with an oil inlet of the peristaltic pump 510. An oil inlet end of the lubricating oil tube 530 communicates with an oil outlet of the peristaltic pump 510, and an oil outlet end of the lubricating oil tube 530 extends to the saw chain 202.

As shown in FIG. 19, the peristaltic pump 510 specifically includes a pump housing 513, a pump body 514, a second motor 511, and a hose 515, where the pump body 514 is disposed in the pump housing 513, a squeezing channel is formed between the pump body 514 and the pump housing 513, the hose 515 is disposed in the squeezing channel, an end of the hose 515 communicates with the oil can 630 through the oil inlet tube 520, the other end of the hose 515 communicates with the oil inlet end of the lubricating oil tube 530, and the second motor 511 can drive the pump body 514 to rotate to squeeze the hose 515.

The second motor 511 can drive the pump body 514 to continuously rotate about a second straight line so that the pump body 514 continuously performs peristaltic squeezing on the hose 515, and the hose 515 is squeezed to generate negative pressure to cause the lubricating oil within the oil can 630 to be sucked into the hose 515.

In some examples, the pump housing 513 includes an upper cover 5132 and a lower cover 5131, two ends of the lower cover 5131 are opened, and the upper cover 5132 covers an opening at the top of the lower cover 5131. The pump housing 513 is configured to be a split structure of the upper cover 5132 and the lower cover 5131 so that the pump body 514 and the hose 515 are easy to assembly in the pump housing 513, and the pump housing 513 is easy to manufacture.

In some examples, the peristaltic pump 510 further includes a deceleration mechanism 512, and an output shaft of the second motor 511 is connected to the pump body 514 through the deceleration mechanism 512. In some specific examples, the deceleration mechanism 512 is a gear structure or a planet gear structure.

In some examples, the pump body 514 includes two disks 5141 spaced apart and arranged in parallel, a mounting column disposed between the two disks 5141, and a squeezing roller 5142 rotatably sleeved on the mounting column, where the squeezing roller 5142 is used for squeezing the hose 515, an output end of the deceleration mechanism 512 is connected to one of the disks 5141, and a line between the centers of the two disks 5141 is the second straight line.

Driven by the second motor 511 and the deceleration mechanism 512, the pump body 514 can rotate about the second straight line, and the squeezing roller 5142 is in contact with the hose 515 and moves along the direction of a central axis of the hose 515 to squeeze the hose 515 segment by segment. In some specific examples, multiple mounting columns are disposed between the two disks 5141, the multiple mounting columns are arranged in an annular array, and one squeezing roller 5142 is rotatably sleeved on each mounting column.

In some examples, the peristaltic pump 510 further includes a first joint 516 and a second joint 517 which are both disposed on the pump housing 513, multiple hoses 515 are provided, the first joint 516 is provided with one first oil inlet and multiple first oil outlets, the second joint 517 is provided with one second oil outlet and multiple second oil inlets, the first oil inlet communicates with the oil can 630 through the oil inlet tube 520, the second oil outlet communicates with the oil inlet end of the lubricating oil tube 530, and the multiple hoses 515 are connected in one-to-one correspondence between the multiple first oil outlets and the multiple second oil inlets. The multiple hoses 515 are provided so that an amount of transported lubricating oil can be increased, thereby improving a lubrication effect on the output assembly 200.

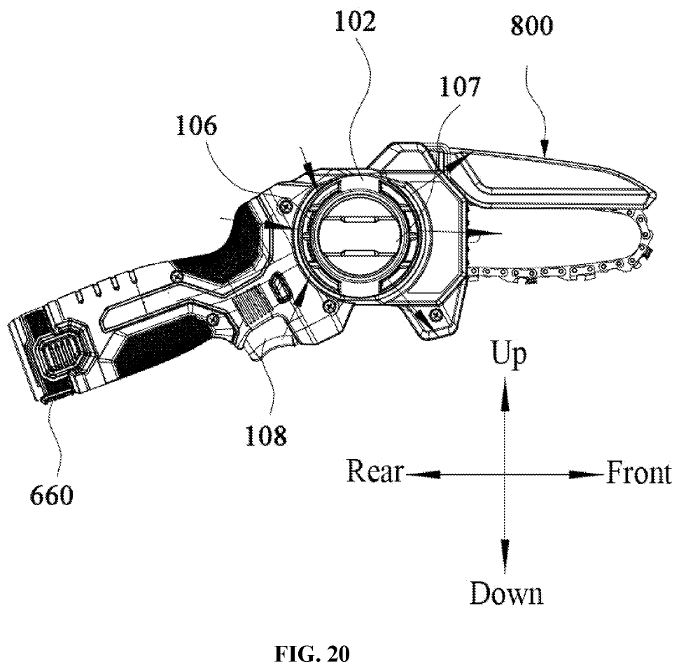

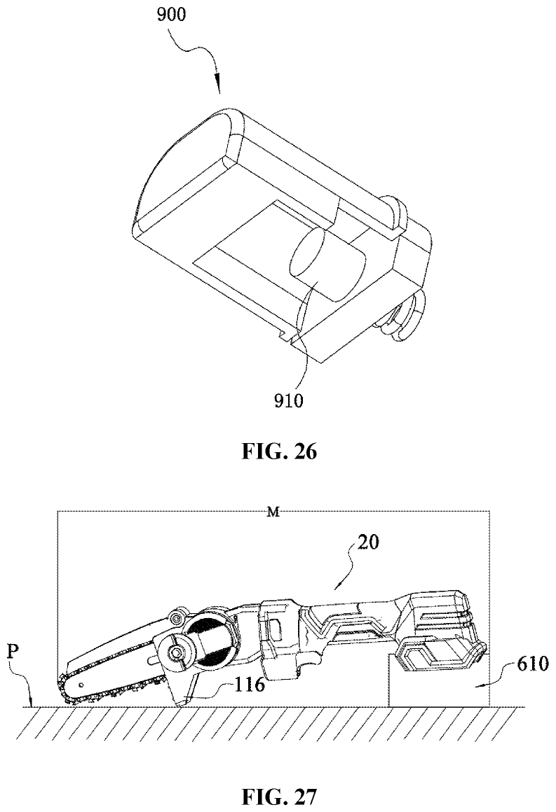

FIGS. 20 to 26 show a new example of the present application.

As shown in FIGS. 20 to 26, this example provides a chainsaw including a housing 100, an output assembly 200, a first motor 300, a transmission assembly, and a circuit board 720. The housing 100 is a main mounting component of the chainsaw, an accommodation space 105 is formed in the housing 100, the first motor 300, the transmission assembly, and the circuit board 720 are all disposed in the accommodation space 105, and the output assembly 200 is mounted at a front end of the housing 100. Specifically, the housing 100 includes a motor accommodation portion 101 and a grip 210, where the motor accommodation portion 101 is used for accommodating the first motor 300, and the grip 210 is used for a user to hold. The output assembly 200 is used for performing a cutting operation. The first motor 300 is disposed in an accommodation space 105 corresponding to the motor accommodation portion 101 and used for supplying power for the output assembly 200 to perform the cutting operation. The transmission assembly is connected between the first motor 300 and the output assembly 200 and used for power transmission.

The first motor 300 and the circuit board 720 generate a large amount of heat in a working process. To perform heat dissipation on components including the first motor 300 and the circuit board 720 in the chainsaw, the housing 100 is formed with an air inlet 106 and an air outlet 107 communicating with the accommodation space 105, where the air inlet 106 and the air outlet 107 are both disposed on the front side of the grip 210 in a front and rear direction, and a heat dissipation airflow entering the accommodation space 105 from the air inlet 106 and flowing out from the air outlet 107 flows through the circuit board 720 and the first motor 300 to dissipate heat of the circuit board 720 and the first motor 300. The front side of the grip may be understood as the front side of a hand holding the grip when the user holds the chainsaw for operation. In some examples, that the heat dissipation airflow flows through the circuit board 720 includes that the heat dissipation airflow flows through a surface or the vicinity of the circuit board 720. In some more specific examples, the circuit board 720, the air inlet 106, and the air outlet 107 are arranged in sequence in a rear to front direction of a saw chain. Although the heat dissipation airflow entering from the air inlet 106 does not flow through the circuit board 720 directly, the heat dissipation airflow can still take away the heat of the circuit board 720 under the action of negative pressure since the heat dissipation airflow can promote the flow of air in the vicinity of the circuit board 720. Compared with a chainsaw with an air inlet disposed behind a grip in the existing art, the chainsaw provided in the example of the present application has the air inlet 106 and the air outlet 107 opened on the front side of the grip 210 so that when the user holds the grip 210 of the chainsaw, the air inlet 106 is not blocked, air intake of the air inlet 106 is not affected, and the air inlet 106 can be configured with a relatively large area, thereby facilitating an improvement of a heat dissipation effect, improving the grip comfort of the user with an overall size reduced, and achieving relatively high heat dissipation efficiency. In some examples, air inlets may be disposed on both the front side and the rear side of the grip.

As shown in FIG. 20, the housing 100 is a split structure, a left housing and a right housing are spliced into the housing 100, and an inner wall surface of the left housing and an inner wall surface of the right housing surround the accommodation space 105. The housing 100 into which the left housing and the right housing are spliced is manufactured with low difficulty and facilitates the assembly of other components inside and outside the housing 100. In other examples of the present application, an upper housing and a lower housing or more housings may be spliced into the housing 100.

The output assembly 200 includes the saw chain, a guide plate, and an upper shield 800, where the guide plate is mounted at the front end of the housing 100 and disposed vertically, the saw chain is sleeved on the guide plate and can be guided by the guide plate to move around the guide plate, and the upper shield 800 is fixed above the guide plate and the saw chain and used for protecting the saw chain. The guide plate extends substantially along the front and rear direction. The saw chain moves in a vertical plane to perform the cutting operation on a workpiece to be cut. It is to be noted that a region where the output assembly 200 is located is a cutting region of the chainsaw, and the vertical plane where the saw chain is located is a cutting plane of the chainsaw. In some examples, as shown in FIG. 20, the output assembly 200 is connected to one side of the housing 100, for example, connected to the left side of the left housing or the right side of the right housing.

The first motor 300 is disposed in the accommodation space 105 corresponding to the motor accommodation portion 101 of the housing 100, and an output shaft of the first motor 300 is disposed substantially along a horizontal direction, that is, the output shaft of the first motor 300 extends in a direction substantially perpendicular to the cutting plane of the output assembly 200. The output shaft of the first motor 300 faces the side of the output assembly 200. When the output assembly 200 is connected to the left side of the left housing, an output end of the output shaft is disposed on the left side of the first motor 300. In some examples, the first motor 300 employs a first servomotor or a first stepper motor. A fan is connected to the other end of the output shaft of the first motor 300, where the fan can synchronously rotate with the output shaft of the first motor 300 to achieve heat dissipation of the first motor 300.

The transmission assembly is connected between the output shaft of the first motor 300 and the saw chain. Specifically, the transmission assembly is a gearbox including a casing, a cover, and a planet gear mechanism, where the planet gear mechanism is disposed in a space defined by the casing and the cover and includes an outer ring gear, a planet carrier, planet gears, and a sun gear, each planet gear is rotatably connected to the planet carrier by a pin shaft, the sun gear meshes with the planet gears, the output shaft of the first motor 300 is connected to the sun gear, the outer ring gear is sleeved outside the planet carrier and meshes with the planet gears, a planet carrier shaft of the planet carrier penetrates through the cover and is connected to a sprocket, and the sprocket meshes with the saw chain. The output shaft of the first motor 300 can output torque and a rotational speed to the sprocket under the deceleration action of the transmission assembly, the rotation of the sprocket can drive the saw chain to move, and the saw chain in motion can perform the cutting operation on the workpiece to be cut.

In some examples, the air inlet 106 is disposed on a side of the motor accommodation portion 101 facing away from the cutting region of the output assembly 200, and the air outlet 107 is disposed on a side of the motor accommodation portion 101 facing the cutting region of the output assembly 200. In this manner, debris generated during the cutting operation of the chainsaw can be prevented from being sucked into the chainsaw through the air inlet 106. In some other examples, the air inlet 106 and the air outlet 107 may be arranged up and down in a vertical direction, for example, the air inlet 106 is disposed above the air outlet 107, or the air outlet 107 is disposed above the air inlet 106.

Still referring to FIG. 20, the motor accommodation portion 101 of the housing 100 has an annular sidewall 102 protruding relative to the grip 210, the air inlet 106 is opened on a side of the annular sidewall 102 facing the grip 210, and the air outlet 107 is opened on a side of the annular sidewall 102 facing away from the grip 210. In this manner, the air inlet 106 is disposed rearward, and the air outlet 107 is disposed forward, thereby facilitating the flow of air into and out of the chainsaw to form the heat dissipation airflow and an increase of an air inlet area of the air inlet 106 and an air outlet area of the air outlet 107.

In some examples, the air inlet 106 and the air outlet 107 are disposed on the same housing of the housing 100 and disposed on the same side of the chainsaw as the fan in the housing 100, the fan is sleeved on the output shaft of the first motor 300 and can rotate with the output shaft, and the air inlet 106 and the air outlet 107 are disposed on two sides of the fan. In this manner, a flowrate of the heat dissipation airflow can be increased, thereby improving the heat dissipation effect. It is to be noted that the transmission assembly and the fan are connected to two sides of the output shaft of the first motor 300.

Still referring to FIG. 20, the circuit board 720 is adjacent to the first motor 300, and the circuit board 720 is disposed on a side of the first motor 300 facing the grip 210. The circuit board 720 is disposed in the vicinity of the first motor 300 so that the heat dissipation effect on the circuit board 720 can be improved, and the overall size of the chainsaw can be reduced, thereby facilitating the miniaturization of the chainsaw. In some examples, a driver circuit electrically connected to the first motor 300 and a controller are disposed on the circuit board 720 so that the first motor 300 can be controlled through the circuit board 720.

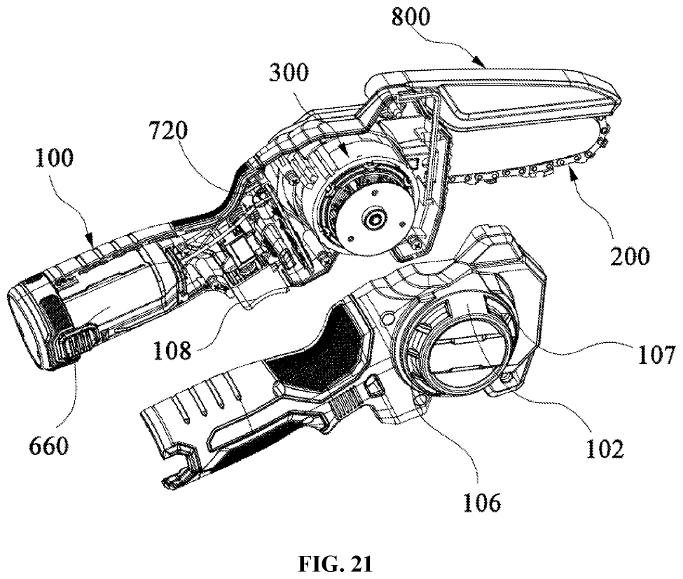

Referring to FIGS. 20 and 21, the chainsaw in this example further includes a battery pack 660 for supplying electrical energy to the chainsaw. Specifically, the battery pack 660 is detachably connected to the chainsaw and disposed in a space formed by the grip 210. The chainsaw further includes a trigger 108 for the user to operate. When the user presses the trigger 108, the first motor 300 is electrically connected to the battery pack 660. In some examples, the trigger 108 is further configured to adjust a rotational speed of the first motor 300. In the preceding example, the air inlet is disposed on the front side of the grip, facilitating a decrease of the distance from the trigger 108 to a rear end of the battery pack 660. In this example, the air inlet 106 is at least partially disposed on the front side of the trigger 108 in the front and rear direction.

Still referring to FIG. 21, the chainsaw further includes the battery pack 660, and the battery pack 660 is disposed in an accommodation space 105 corresponding to the grip 210. The circuit board 720 is disposed between the first motor 300 and the battery pack 660. In some examples, the battery pack 660 may be detachably connected outside the grip 210.

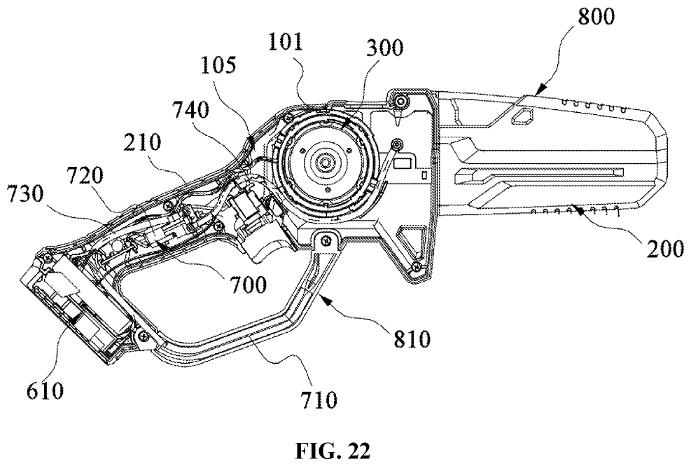

Still referring to FIG. 22, the chainsaw further includes a lubrication assembly 700, where the lubrication assembly 700 is used for lubricating the chainsaw and includes an oil can 710, an oil pump 720, an oil suction tube 730, and an oil discharge tube 740, the oil can 710 is used for containing lubricating oil, the oil pump 720 is used for supplying power for the lubricating oil to flow, an end of the oil suction tube 730 communicates with an oil inlet of the oil pump 720, the other end of the oil suction tube 730 extends into the oil can 710, an end of the oil discharge tube 740 communicates with an oil outlet of the oil pump 720, and the other end of the oil discharge tube 740 extends to the saw chain. Driven by the oil pump 720, the lubricating oil within the oil can 710 can be transported to the saw chain through the oil suction tube 730, the oil pump 720, and the oil discharge tube 740 to lubricate the saw chain.

In some examples, an oil outlet end of the oil discharge tube 740 is connected to an oil outlet nozzle, the oil outlet nozzle extends into a sealing ring, the sealing ring is fixedly disposed on the housing 100, the lubricating oil in the oil discharge tube 740 flows through the oil outlet nozzle into an oil collecting chamber enclosed between the sealing ring and the housing 100, and the saw chain in motion passes through the oil collecting chamber and adheres to the lubricating oil so that the saw chain is lubricated. In some more specific examples, the oil discharge tube 740, the oil outlet nozzle, and the sealing ring are integrated into a whole to save a cost and facilitate assembly.

Still referring to FIGS. 22 to 25, the chainsaw further includes a lower hand guard 810 connected below the grip 210, two ends of the lower hand guard 810 are connected to front and rear ends of the grip 210 separately so as to form an annular space, and the user places fingers in the annular space when holding the grip 210 of the chainsaw so that the fingers can be protected, preventing the hand of the user from being injured by a broken saw chain. Additionally, the chainsaw is provided with the lower hand guard 810 to facilitate storage of the chainsaw. For example, the lower hand guard 810 may be hung on a branch or a hook so that it is convenient for the user to free the hand to do other work.

In some examples, the thickness of the lower hand guard 810 is greater than or equal to 5 mm and less than or equal to 20 mm, for example, the thickness of the lower hand guard 810 may be 5 mm, 7 mm, 10 mm, 12 mm, 15 mm, 19 mm, or 20 mm.

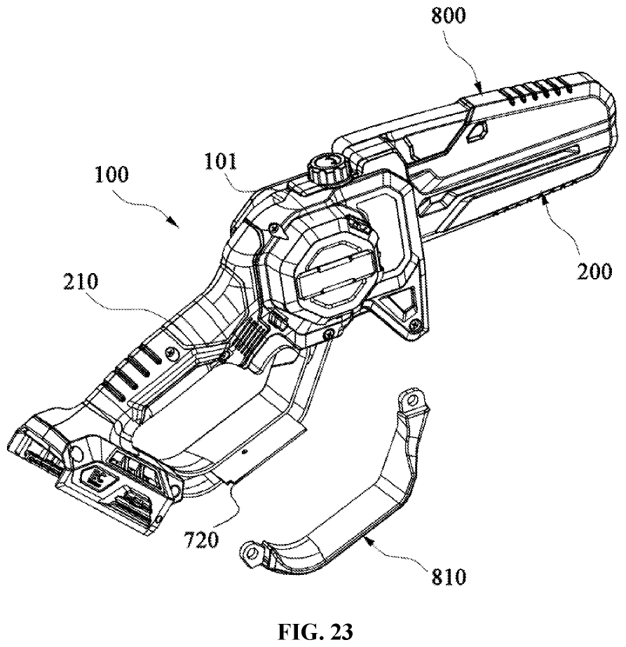

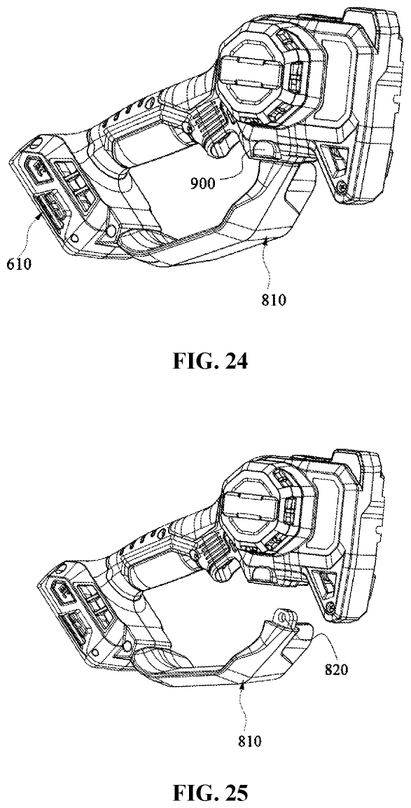

To facilitate maintenance and replacement of the lower hand guard 810, in some examples, as shown in FIGS. 23 to 25, the lower hand guard 810 is detachably connected to the grip 210. Specifically, a limiting hole 820 is disposed at each of two ends of the lower hand guard 810, and a limiting column 910 is disposed on the housing 100. The limiting hole 820 is inserted into the limiting column 910 so that the lower hand guard 810 is detachably connected to the grip 210. In addition to this method, the lower hand guard 810 may be detachably connected to the grip 210 in a snap-fit manner. Still referring to FIGS. 24 to 26, the chainsaw further includes a switch lock 900 movably disposed on the housing 100 by an elastic member, and the limiting column 910 protrudes on the switch lock 900.

It is to be noted that the lower hand guard 810 must be disposed on the chainsaw according to the foreign safety requirements set for the chainsaw, but the lower hand guard 810 does not necessarily need to be disposed on the chainsaw in China and many domestic users are not accustomed to the existence of the lower hand guard 810 when using the chainsaw. Therefore, the lower hand guard 810 is detachably connected to the grip 210 so that the lower hand guard 810 can be detached and mounted according to the habits of the user and a geographic location for use, thereby meeting use requirements of users.

In some examples, the oil can 710 is at least partially disposed or formed within the lower hand guard 810. The oil can 710 is disposed within the lower hand guard 810 in the chainsaw so that a space inside the lower hand guard 810 can be fully utilized, which facilitates a decrease of the size of a main portion of the chainsaw and the miniaturization of the chainsaw and can improve user experience. It is to be noted that if the oil can 710 is disposed or formed within the lower hand guard 810, it is better that the lower hand guard 810 is fixedly connected to the grip 210 so as to avoid oil leakage due to poor sealability caused by a detachable connection.

In some examples, the oil can 710 has an oil filler disposed on an upper surface of the lower hand guard 810, so as to facilitate refueling into the oil can 710.

In some examples, the lower hand guard 810 and the oil can 710 share the same housing, that is, at least part of a housing of the lower hand guard 810 forms an oil can housing of the oil can 710, and an accommodation space for accommodating the lubricating oil is formed within the lower hand guard 810. In this manner, the space inside the lower hand guard 810 can be fully utilized, and the volume of oil inside the lower hand guard 810 can be increased. In some other examples, the oil can 710 includes an independent oil can housing connected to an inner wall surface of the housing of the lower hand guard 810.

In some examples, the oil pump 720 is disposed within the lower hand guard 810. In this manner, the space inside the lower hand guard 810 can be further fully utilized, thereby further reducing the size of the main portion of the chainsaw.

Still referring to FIG. 22, the oil pump 720 may be disposed within the grip 210 so that a space inside the grip 210 can be further fully utilized.

In some examples, the oil pump 720 is disposed at a middle position of the grip 210, and the oil suction tube 730 extends into the lower hand guard 810 from front to rear. In some other examples, the oil pump 720 is disposed at the middle position of the grip 210, and the oil suction tube 730 extends into the lower hand guard 810 from rear to front.

To improve an operation environment of the chainsaw, a lighting mechanism is disposed on the upper shield 800 of the output assembly 200. The cutting region is illuminated by the lighting mechanism so that the user can clearly acquire a cutting progress and control a cutting direction, thereby improving cutting quality.

In some examples, the upper shield 800 is transparent and made of a transparent material. An outer side surface of the upper shield 800 may be sanded or otherwise treated to block light. An inner sidewall of the upper shield 800 is inclined to transmit light towards the guide plate, or a light guide column is disposed in the upper shield 800 to guide light to above the saw chain, thereby enhancing a light intensity at the saw chain and improving a visual effect.

In some examples, the lighting mechanism is an LED lamp directly controlled by a control mechanism of the chainsaw. Under the control of the control mechanism, the LED lamp may be configured to be lit ahead of time. In this example, the control mechanism may be a centralized or distributed controller. For example, the controller may be one separate single-chip microcomputer or may be composed of multiple distributed single-chip microcomputers. The single-chip microcomputer can run control programs to control the LED lamp to implement its function. It is to be noted that the control mechanism and the preceding circuit board 720 may be integrated or may be two independent mechanisms. In addition to the LED lamp, the lighting mechanism may employ a halogen lamp, a high-pressure sodium lamp, a low-pressure sodium lamp, or another lamp capable of implementing a lighting operation.

In some examples, the lighting mechanism is connected to the battery pack 660 through a wire, and the battery pack 660 supplies electrical energy to the lighting mechanism. In some other examples, the chainsaw may also be provided with a solar cell panel on an outer wall surface of the upper shield 800, the lighting mechanism is electrically connected to the solar cell panel, and the lighting mechanism is powered by the solar cell panel. In addition to the lighting mechanism, the solar cell panel may supply power to other electric components of the chainsaw, and the solar cell panel may even completely replace the battery pack 660 if enough electrical energy is supplied.

In some examples, the wire is arranged on one side of the upper shield 800. In some examples, an end of the upper shield 800 is rotatably connected to the housing 100 through a rotating shaft, and a torsion spring is sleeved on the rotating shaft to provide a torsion force for resetting the upper shield 800. Part of the wire within the upper shield 800 may be integrated with the torsion spring to both conduct electricity and provide the torsion force.

Generally, the lighting mechanism is disposed on the upper shield 800 and rotates synchronously with the upper shield 800 to facilitate maintenance and replacement of the lighting mechanism. In other examples, the lighting mechanism may be fixedly disposed on the housing 100 so as not to rotate synchronously with the upper shield 800. When the lighting mechanism is disposed on the housing 100, the rotating shaft through which the upper shield 800 is rotatably connected to the housing 100 may be made of a light guide material so that the rotating shaft can both achieve a rotational connection and guide light. The upper shield 800 is also made of the light guide material so that the upper shield 800 has both a protective effect and a light guide effect. Light emitted from the lighting mechanism can enter the upper shield 800 through the rotating shaft so that the upper shield 800 emits light. The lighting mechanism may be directly disposed within the rotating shaft, and the rotating shaft is rotatably connected to the housing 100 and locked by a screw so that the lighting mechanism is fixed and mounted.

As shown in FIG. 27, when the chainsaw is placed on a horizontal plane P, the housing 200 has a protruding support housing 116 so that the chain 100 will not touch the horizontal plane P when the chainsaw is placed on the horizontal plane. On a side where a battery pack 610 is mounted, the battery pack 610 may also touch the horizontal plane P. With such placement, the distance of the power tool (including the chainsaw) in the front and rear direction is defined as a total length M. That is, when the power tool (including the chainsaw) with the battery pack 610 mounted is placed on the horizontal plane, the distance of the power tool in the front and rear direction is the total length M.

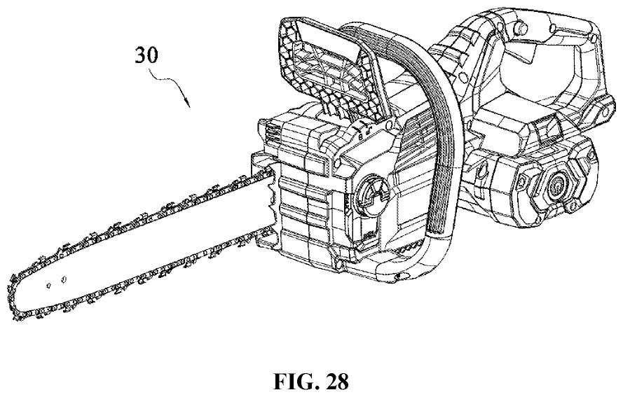

It is to be noted that all examples of the present application are applicable to chainsaws of various sizes. The chainsaw may be the chainsaw (10 or 20) that can be held with a single hand, as shown in FIGS. 1 to 27, or the chainsaw may be a chainsaw 30 that may require a second handle, as shown in FIG. 28.

In an example, an overall weight of the chainsaw 20 with no battery pack mounted is greater than or equal to 1 kg and less than or equal to 3 kg, and an overall weight of the chainsaw 20 with the battery pack mounted is greater than or equal to 1.2 kg and less than or equal to 4 kg. The total length M of the chainsaw 20 is greater than or equal to 20 cm and less than or equal to 60 cm. Power of the first motor of the chainsaw 20 in operation is greater than or equal to 200 W and less than or equal to 800 W. Power of the liquid pump 410 in operation is greater than or equal to 0.2 W and less than or equal to 5 W.

In another example, an overall weight of the chainsaw 30 with no battery pack mounted is greater than or equal to 2 kg and less than or equal to 8 kg, and an overall weight of the chainsaw 30 with the battery pack mounted is greater than or equal to 2.4 kg and less than or equal to 12 kg. The total length M of the chainsaw 30 is greater than or equal to 50 cm and less than or equal to 150 cm. Power of the first motor of the chainsaw 30 in operation is greater than or equal to 500 W and less than or equal to 6000 W. Power of the liquid pump 410 in operation is greater than or equal to 0.2 W and less than or equal to 5 W. Both the chainsaw 20 and the chainsaw 30 belong to the power tool.

To conclude, in an example, the total length M of the chainsaw is greater than or equal to 20 cm and less than or equal to 150 cm; in an example, the total length M of the chainsaw is greater than or equal to 20 cm and less than or equal to 120 cm; in an example, the total length M of the chainsaw is greater than or equal to 20 cm and less than or equal to 100 cm; in an example, the total length M of the chainsaw is greater than or equal to 20 cm and less than or equal to 80 cm.

It should be understood that, the oil pump in this application not only means a pump for oil, but also means a pump for other liquid. The expression of “oil pump” is used here for easy understanding. For the same reason, the oil can not only means a can for oil, but also means a can for other liquid, such as water. The names of different parts are not intended to limit the function of those parts.

The present application has the following beneficial effects: in one aspect, compared with a transmission assembly disposed between the first motor and the liquid pump, the second motor drives the liquid pump in the present application, two motors are independently arranged, and the second motor and the liquid pump are integrated so that it is convenient to independently control the liquid pump to release the liquid by the second motor, and a space occupied by a transmission structure between the first motor and the liquid pump is saved. In another aspect, in the power tool, at least part of the liquid pump assembly is disposed inside the grip formed by the housing so that a space inside the grip is reasonably utilized, thereby facilitating the miniaturization of the power tool.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A power tool, comprising:
an output assembly for implementing an operation;
a first motor for driving the output assembly to operate;
a housing formed with a grip for a user to hold; and
a liquid pump assembly comprising a liquid pump and a second motor for driving the liquid pump to operate;
wherein the liquid pump assembly is at least partially disposed within the grip, and a total length M of the power tool is greater than or equal to 20 cm and less than or equal to 150 CM.

2. The power tool according to claim 1, wherein the second motor and the liquid pump are both disposed within the grip.

3. The power tool according to claim 1, wherein the liquid pump assembly further comprises an oil can to lubricate the output assembly, and the oil can is at least partially disposed on a front side of the first motor.

4. The power tool according to claim 1, wherein along an operation direction of the power tool, the liquid pump and the second motor are arranged substantially in a front and rear direction.

5. The power tool according to claim 4, wherein along the operation direction of the power tool, the liquid pump is disposed on a front side of the second motor.

6. The power tool according to claim 1, wherein the liquid pump and the second motor both extend along a preset direction at a preset angle relative to a horizontal direction.

7. The power tool according to claim 1, further comprising a battery pack coupling portion for coupling a battery pack.

8. The power tool according to claim 7, further comprising a circuit board at least partially disposed within a housing of the battery pack coupling portion.

9. The power tool according to claim 1, further comprising a circuit board for controlling both the first motor and the second motor.

10. The power tool according to claim 1, further comprising a circuit board disposed between the first motor and at least part of the liquid pump assembly.

11. The power tool according to claim 3, wherein the liquid pump assembly comprises an oil tube and a squeezing piece, the oil tube comprises an oil inlet end communicating with the oil can and an oil outlet end extending to the output assembly, and the squeezing piece is configured to squeeze the oil tube into deformation so that lubricating oil within the oil can is transportable to the output assembly through the oil tube.

12. The power tool according to claim 11, wherein the first motor is drivingly connected to the squeezing piece and configured to drive the squeezing piece to rotate about a first straight line to squeeze the oil tube into deformation so that the lubricating oil within the oil can is transported to the output assembly through the oil tube.

13. The power tool according to claim 1, further comprising an oil can for storing at least a liquid; wherein the liquid pump provides pressure for the liquid to flow so that the liquid within the oil can is capable of being released or sucked in, and the liquid pump comprises a soft cover made of a flexible material and configured to be deformable to compress the liquid.

14. The power tool according to claim 1, wherein the housing is formed with an accommodation space in which a circuit board is disposed, the housing is formed with an air inlet and an air outlet communicating with the accommodation space, the air inlet and the air outlet are both disposed on a front side of the grip in a front and rear direction; and a heat dissipation airflow entering the accommodation space from the air inlet and flowing out from the air outlet flows through the circuit board and the first motor.

15. The power tool according to claim 1, further comprising a lower hand guard connected below the grip and a lubrication assembly for lubricating a saw chain, wherein the lubrication assembly comprises an oil can at least partially disposed or formed within the lower hand guard.

16. A chainsaw, comprising:
a chain for implementing a cutting operation;
a guide plate extending along a front and rear direction and used for guiding the chain;
a first motor for driving the chain to perform the cutting operation;
a housing formed with a grip for a user to hold;
a liquid pump assembly comprising a liquid pump and a second motor for driving the liquid pump to operate to lubricate or cool the chain; and
an oil can for lubricating the chain;
wherein the liquid pump assembly is at least partially disposed within the grip, and the first motor is disposed between the oil can and the liquid pump assembly.

17. The chainsaw according to claim 16, wherein a power of the liquid pump in operation is greater than or equal to 0.2 W and less than or equal to 5 W.

18. The chainsaw according to claim 16, wherein a total length of the chainsaw is greater than or equal to 20 cm and less than or equal to 60 cm.

19. The chainsaw according to claim 16, wherein an overall weight of the chainsaw with a battery pack mounted is greater than or equal to 1.2 kg and less than or equal to 4 kg.

20. The chainsaw according to claim 16, wherein a power of the first motor in operation is greater than or equal to 200 W and less than or equal to 800 W.
